(19) United States
(12) Patent Application Publication
(10) Pub. No.: US 2010/0103566 A1
(43) Pub. Date: Apr. 29, 2010

(54) PROTECTION CIRCUIT AND PORTABLE ELECTRONIC DEVICE EMPLOYING THE SAME

(75) Inventor: TIEN-FU CHEN, TU-CHENG (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/568,791

(22) Filed: Sep. 29, 2009

(30) Foreign Application Priority Data
Oct. 29, 2008 (CN) 200810305276.5

(51) Int. Cl. H02H 3/00

(52) U.S. Cl. 361/1

(57) ABSTRACT

An exemplary protection circuit includes a protecting unit for protecting the protection circuit, a detecting unit electrically connected to the protecting unit, and a processor. The detecting unit is configured for detecting whether water enters into the detecting unit or not, and outputting a detecting result. The processor is electrically connected to the protecting unit and the detecting unit, and controls the protecting unit to turn on or cut off in response to the detecting result.

### BACKGROUND

1. Technical Field

The disclosure generally relates to protection circuits, more particularly, to a protection circuit used for protecting a portable electronic device.

2. Description of the Related Art

Portable electronic devices, such as mobile telephones and personal digital assistants (PDAs), may accidentally become wet or damp, which may cause a short in the inner circuits, resulting in serious damage to the portable electronic device. Therefore, it is necessary to prevent water or dampness from damaging the portable electronic device.

At present, to protect the portable electronic device from water or dampness, the designer may improve design processes of the portable electronic device to tightly seal the housings of the portable electronic device. However, after long period of usage, the water or dampness may enter into the housing from the junctions of housings due to abrasion, which may still damage the inner circuits of the portable electronic device.

Therefore, there is room for improvement within the art.

### BRIEF DESCRIPTION OF THE DRAWINGS

Many aspects of a protection circuit and a portable electronic device employing the same can be better understood with reference to the following drawings. The components in the drawings are not necessarily drawn to scale, the emphasis instead being placed upon clearly illustrating the principles of the exemplary protection circuit and the portable electronic device employing the same. Moreover, in the drawings, like reference numerals designate corresponding parts throughout the several views. Wherever possible, the same reference numbers are used throughout the drawings to refer to the same or like elements of an embodiment.

FIG. 1 is a block diagram of a protection circuit, according to an exemplary embodiment.

FIG. 2 is a schematic view of a portable electronic device mounted with a plurality of detecting units, according to the embodiment.

### DETAILED DESCRIPTION OF THE EMBODIMENTS

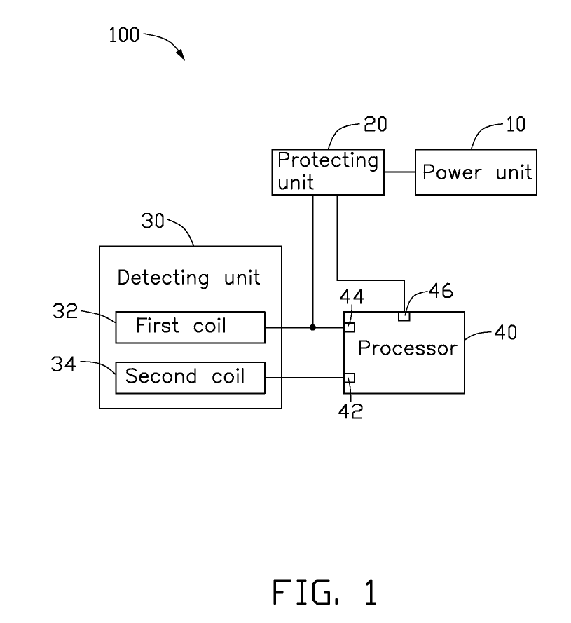

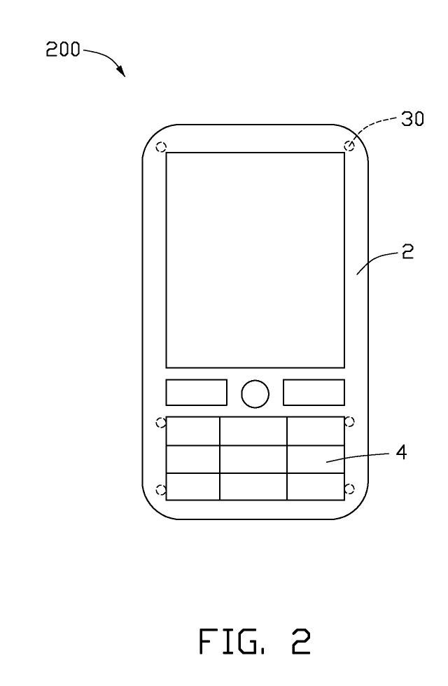

FIGS. 1-2 show an exemplary embodiment of a protection circuit 100 used for protecting a portable electronic device 200. Preferably, the portable electronic device 200 may be a mobile phone, PDA, MP3 player etc. The portable electronic device 200 includes a housing 2, a keyboard 4, and a plurality of I/O (input/output) interfaces (not shown). The keyboard 4 is configured for inputting information.

The protection circuit 100 includes a power unit 10, a protecting unit 20 electrically connected to the power unit 10, a detecting unit 30 electrically connected to the protecting unit 20, and a processor 40. The processor 40 is electrically connected to the protecting unit 20 and the detecting unit 30.

The power unit 10, can be a lithium ion (Li+) battery of the portable electronic device 200, is rechargeable, and configured to provide power to the protection circuit 100 and the portable electronic device 200.

The protecting unit 20 can be a fuse, which can ensure safe operation of the protection circuit 100. When the protection circuit 100 is abnormal, accompanied by rising current, the protecting unit 20 can cut off the current to protect the protection circuit 100.

The detecting unit 30 includes a first coil 32 and a second coil 34. When water or moisture enters between the first coil 32 and the second coil 34, the first coil 32 and the second coil 34 are electrically connected with each other. Referring to FIG. 2, it is to be understood that a plurality of detecting units 30 can be mounted in the housing 2 of the portable electronic device 200 (e.g., junction of housing 2, adjacencies of the keyboard 4, I/O interfaces), so that the detecting units 30 can timely detect whether the water or moisture enters into the portable electronic device 200. A plurality of first coils 32 connected in parallel are electrically connected to a wire, and a plurality of second coils 34 connected in parallel are electrically connected to another wire.

The processor 40 can be a central processing unit (CPU) of the portable electronic device 200 and includes a signal input pin 42 electrically connected to the second coil 34, a power input pin 44, and a signal output pin 46 electrically connected to the protecting unit 20. The power input pin 44 is electrically connected to the first coil 32 and the protecting unit 20, and configured for receiving power from the power unit 10.

The power level of the signal output pin 46 is consistent with the power level of the signal input pin 42. The protecting unit 20 is controlled by the power level of the signal output pin 46, when the power level of the signal output pin 46 is low, the protecting unit 20 works normally, and the power unit 10 provides power to the processor 40. When the power level of the signal output pin 46 is high, the protecting unit 20 is cut off, and the power unit 10 stops providing power to the processor 40. Under normal circumstances (where there is no water or moisture between the firs coil 32 and the second coil 34), the power levels of the signal input pin 42 and the signal output pin 46 are low.

In use, when water or moisture from outside enters between the first coil 32 and the second coil 34, the first coil 32 and second coil 34 become electrically connected with each other. The signal input pin 42 is electrically connected to the power input pin 44 and receives a level signal from a detecting result. The power level of the signal input pin 42 is changed into high level from low level, and the power level of the signal output pin 46 is also changed into high level in response to the power level of the signal input pin 42. The signal output pin 46 outputs the high level signal as a control signal to the protecting unit 20, and the protecting unit 20 cuts off according to the control signal. Thus, the power unit 10 stops providing power to the processor 40 for protecting the portable electronic device 200.

The protecting unit 20 can be designed as all in one and a removable module. When the water or moisture in the portable electronic device 200 is cleaned up, a new fuse can be use to replace the damaged fuse, and the protecting unit 20 can be reset into the protection circuit 100.

The first coil 32 can be electrically connected to the power input pin 44, and the second coil 34 can be electrically connected to the signal input pin 42 simultaneously.

The protection circuit 100 has a simple structure and manufacturing process. When the portable electronic device 200 is in a wet environment or falls into water, the protection circuit 100 can automatically power off to prevent the inner circuits from damage. Thus, the protection circuit 100 can protect the portable electronic device 200.

It is to be understood, however, that even though numerous characteristics and advantages of the exemplary invention have been set forth in the foregoing description, together with details of the structure and function of the exemplary invention, the disclosure is illustrative only, and changes may be made in detail, especially in matters of shape, size, and arrangement of parts within the principles of exemplary invention to the full extent indicated by the broad general meaning of the terms in which the appended claims are expressed.

What is claimed is:

1. A protection circuit, comprising:
a protecting unit;
a detecting unit electrically connected to the protecting unit and configured for detecting whether water enters into the detecting unit or not, and outputting a detecting result; and
a processor electrically connected to the protecting unit and the detecting unit, wherein the processor controls the protecting unit to turn on or cut off the protecting unit in response to the detecting result.

2. The protection circuit as claimed in claim 1, further comprising a power unit electrically connected to the protecting unit, wherein the power unit is configured for providing power for the protection circuit.

3. The protection circuit as claimed in claim 1, wherein the processor comprises a power input pin electrically connected to the protection unit and the detecting unit, the processor is electrically connected with a power source via the power input pin.

4. The protection circuit as claimed in claim 3, wherein the processor further comprises a signal input pin electrically connected to the detecting unit, the signal input pin configured for receiving the detecting result from the detecting unit.

5. The protection circuit as claimed in claim 4, wherein the processor further comprises a signal output pin electrically connected to the protecting unit, the signal output pin outputs a control signal in response to the detecting result to control the protecting unit to turn on or cut off.

6. The protection circuit as claimed in claim 5, wherein the detecting unit comprises a first coil and a second coil; when water enters between the first coil and the second coil, the first coil and the second coil are electrically connected with each other, and the signal output pin outputs the control signal to control the protecting unit to cut off.

7. The protection circuit as claimed in claim 5, further comprising a plurality of detecting units electrically connected to the protecting unit and the processor.

8. A portable electronic device, comprising:
a housing; and
a protection circuit mounted in the housing, comprising:
a protecting unit;
a detecting unit electrically connected to the protecting unit and configured for detecting whether water enters into the detecting unit or not, and outputting a detecting result; and
a processor electrically connected to the protecting unit and the detecting unit, wherein the processor controls the protecting unit to turn on or cut off the protecting unit in response to the detecting result.

9. The portable electronic device as claimed in claim 8, the protection circuit further comprises a power unit electrically connected to the protecting unit, wherein the power unit is configured for providing power for the portable electronic device.

10. The portable electronic device as claimed in claim 8, wherein the processor comprises a power input pin electrically connected to the protection unit and the detecting unit, the processor is electrically connected with a power source via the power input pin.

11. The portable electronic device as claimed in claim 10, wherein the processor further comprises a signal input pin electrically connected to the detecting unit, the signal input pin configured for receiving the detecting result from the detecting unit.

12. The portable electronic device as claimed in claim 11, wherein the processor further comprises a signal output pin electrically connected to the protecting unit, the signal output pin outputs a control signal in response to the detecting result to control the protecting unit to turn on or cut off.

13. The portable electronic device as claimed in claim 12, wherein the detecting unit comprises a first coil and a second coil; when water enters between the first coil and the second coil, the first coil and the second coil are electrically connected with each other, and the signal output pin outputs the control signal to control the protecting unit to cut off.

14. The portable electronic device as claimed in claim 8, wherein the protection circuit comprises a plurality of detecting units electrically connected to the protecting unit and the processor.

15. The portable electronic device as claimed in claim 14, further comprising a keyboard for inputting information; wherein the detecting units are mounted at the junctions of the housing, adjacencies of the keyboard.
